(19) United States
(12) Patent Application Publication
(10) Pub. No.: US 2024/0367953 A1
(43) Pub. Date: Nov. 7, 2024

(54) HOUSING FOR A WINCH RING

(71) Applicant: ARB Corporation Limited, Kilsyth (AU)

(72) Inventors: Daniel Jason Bongard, Kilsyth (AU); Andrew Harry Brown, Kilsyth (AU); John Desmond Clark, Kilsyth (AU)

(21) Appl. No.: 18/644,882

(22) Filed: Apr. 24, 2024

(30) Foreign Application Priority Data
May 3, 2023 (AU) 2023901319

(51) Int. Cl. B66D 3/04

(52) U.S. Cl. CPC B66D 3/046

(57) ABSTRACT

Disclosed is a housing (10) for a winch ring (12) carrying a cable (14). The winch ring (12) defines a central aperture (16) having an axis (18), and a peripheral region defining an annular groove (20) for receiving the cable (14). The housing (10) includes opposed gripping members (24) joined by at least one bridging portion (26). Each gripping member (24) is releasably mountable to a side of the winch ring (12) to position the at least one bridging portion (26) across the annular groove (20). The at least one bridging portion (26) is shaped to extend about the axis (18) to enclose a portion of the annular groove (20) to inhibit removal of the cable (14) from the winch ring (12). The gripping members (24) are mountable to the winch ring (12) to permit relative rotation of the peripheral region of the winch ring (12) and the housing (10) about the axis (18). At least one of the gripping members (24) is shaped to at least partially surround the central aperture (16) to allow access through the central aperture (16). Also disclosed is an assembly (50) for carrying the winch cable (14), and a winch assembly (30).

### CROSS-REFERENCE TO RELATED APPLICATION

The application claims priority to Australian provisional patent application no. 2023901319, filed 3 May 2023, the contents of which are incorporated herein in their entirety.

### TECHNICAL FIELD

The present disclosure relates, generally, to winch assemblies used in connection with vehicles, and, particularly, to winch rings used to direct a winch cable, and/or amplify cable tension, during winch operations.

### BACKGROUND

A winch ring (also known as a snatch ring, recovery ring, or winch pulley) is employed during winching operations to act as a pulley to direct a cable under tension. Winch rings typically define a central aperture extending through the ring to allow another cable, rope, or other flexible element such as a soft shackle, to be secured through the ring and to another structure. This arrangement allows the winch ring to act as a readily installable coupling which provides the advantages of a pulley.

Winch rings are commonly used with vehicle mounted, electrically powered winches to couple a winch cable to a soft shackle which, in turn, is attached to a static structure, such as a tree, or another vehicle, to provide a stable base to draw the vehicle towards. The cable is carried by the winch ring by winding partway around a groove defined by the winch ring. The cable is typically then returned back on itself and attached to the vehicle. The winch is operated to wind the cable around a spool which causes the vehicle to be drawn towards the winch ring. This can allow removing the vehicle from a precarious position, such as being located in deep water, and/or on unfirm ground.

While winch rings often offer advantages over more complex, alternative coupling solutions, such as snatch blocks, they can be unreliable as can allow the cable to be separated from the winch ring during a winching operation. When this occurs, a user typically must cease winching and manually re-wind the cable about the ring to allow continuing winching. For example, should a user incorrectly install the cable to the winch ring, such as by positioning the axis of the ring to be non-perpendicular to the longitudinal axis of the cable, this can cause the cable to slip out of the groove and off the ring when the cable is tensioned by the winch. Also, where a vehicle is being winched concurrently with the vehicle being driven, the vehicle can suddenly grip the ground causing it to lurch forward. This can cause the cable to slacken and consequently fall off the winch ring. Such instances can significantly increase duration of a winching operation which is inconvenient and, in some situations, can be unsafe.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to some disclosed aspects, there is provided a housing for a winch ring carrying a cable. The winch ring defines a central aperture having an axis, and a peripheral region defining an annular groove for receiving the cable. The housing includes opposed gripping members joined by at least one bridging portion, each gripping member configured to be releasably mountable to a side of the winch ring to position the at least one bridging portion across the annular groove. The at least one bridging portion is shaped to extend about the axis to enclose a portion of the annular groove to inhibit removal of the cable from the winch ring. The gripping members are mountable to the winch ring to permit relative rotation of the peripheral region and the housing about the axis. At least one of the gripping members is shaped to at least partially surround the central aperture to allow access through the central aperture.

The gripping members may be biased towards each other.

The gripping members and the at least one bridging portion may be integrally formed such that the gripping members are resiliently pivotable relative to the at least one bridging portion.

Each gripping member may define a free end extending away from the at least one bridging portion, and a portion of each gripping member adjacent the free end is arranged to diverge away from the corresponding portion of the other gripping member.

At least one of the gripping members may be shaped to encircle the central aperture.

Each gripping member may define an aperture dimensioned to surround a hub arranged through the central aperture, and each gripping member define at least one cut out arranged to centralise the aperture on the hub.

At least one bridging portion may be arranged to extend around at least 90 degrees about the axis of the winch ring.

A central bridging portion may be interposed between a pair of spaced side bridging portions, and the bridging portions be arranged to extend about more than 90 degrees about the axis of the winch ring.

Each side bridging portion may define a split extending perpendicular to the axis to divide the side bridging portion into two sections, whereby the two sections are separable when the gripping members are urged apart when being mounted on the winch ring.

Each side bridging portion may define a flared outer edge section.

According to other disclosed embodiments, there is provided an assembly for carrying a winch cable. The assembly includes a winch ring defining a central aperture, and a peripheral annular groove for receiving the winch cable, and a housing having opposed gripping members joined by at least one bridging portion. Each gripping member is configured to be releasably mountable to a side of the winch ring to position the at least one bridging portion across the annular groove. The at least one bridging portion is shaped to extend about the axis to enclose a portion of the annular groove to inhibit removal of the cable from the winch ring. The gripping members are mountable to the winch ring to permit relative rotation about the axis, and at least one of the gripping members is shaped to at least partially surround the central aperture to allow access through the central aperture.

The winch ring may include a body defining the annular groove and the central aperture, and a hub mounted to the body in the central aperture, and the gripping members are mountable to the hub.

The hub may be fixedly secured to the body such that the hub is rotatably locked to the body.

The hub may define a rounded entrance and exit to the central aperture.

According to further disclosed embodiments, there is provided a winch assembly including: an electrically powered winch connected to a cable and operable to wind the cable to adjust its effective length; a winch ring defining a central aperture, and a peripheral annular groove for receiving the cable; and a housing having opposed gripping members joined by at least one bridging portion, each gripping member configured to be releasably mountable to a side of the winch ring to position the at least one bridging portion across the annular groove, the at least one bridging portion shaped to extend about the axis to enclose a portion of the annular groove to inhibit removal of the cable from the winch ring, the gripping members being mountable to the winch ring to permit relative rotation about the axis, and at least one of the gripping members shaped to at least partially surround the central aperture to allow access through the central aperture.

The winch assembly may include a shackle releasably securable through the central aperture.

It will be appreciated embodiments may comprise steps, features and/or integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompany drawings in which:

FIG. 1 is a perspective view of a winch assembly in a first configuration;

FIG. 2 is a top view of the winch assembly of FIG. 1 in a second configuration;

FIGS. 3 and 4 are two perspective views of an assembly for carrying winch cable, illustrating the assembly partially disassembled; and

FIGS. 5 and 6 are top and perspective views, respectively, of a component of the assemblies shown in the previous figures, being a housing for a winch ring.

### DESCRIPTION OF EMBODIMENTS

In the drawings, reference numeral 10 generally designates a housing 10 for a winch ring 12 carrying a cable 14. The winch ring 12 defines a central aperture 16 having an axis 18, and a peripheral region defining an annular groove 20 for receiving the cable 14. The housing 10 includes opposed gripping members 24 joined by at least one bridging portion 26. Each gripping member 24 is releasably mountable to a side of the winch ring 12 to position the at least one bridging portion 26 across the annular groove 20. The at least one bridging portion 26 is shaped to extend about the axis 18 to enclose a portion of the annular groove 20 to inhibit removal of the cable 14 from the winch ring 12. The gripping members 24 are mountable to the winch ring 12 to permit relative rotation of the peripheral region of the winch ring 12 and the housing 10 about the axis 18. At least one of the gripping members 24 is shaped to at least partially surround the central aperture 16 to allow access through the central aperture 16.

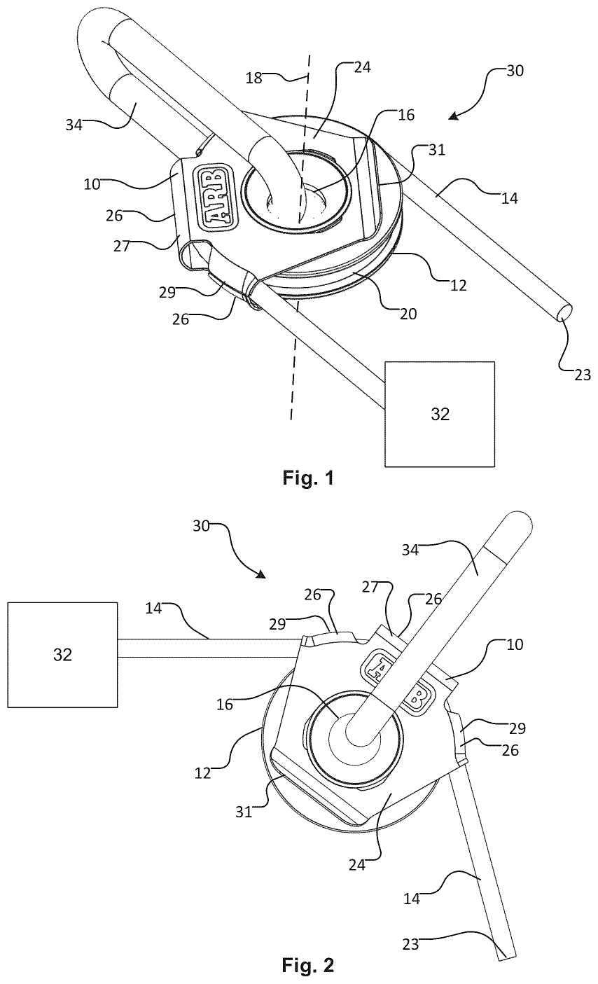

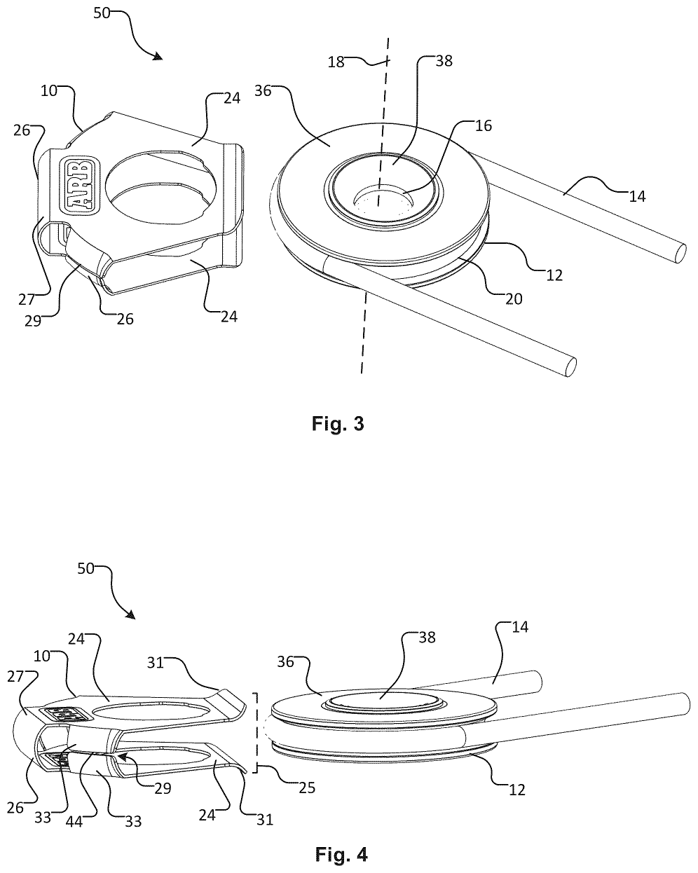

FIGS. 1 and 2 show a winch assembly 30 in two different configurations. The assembly 30 includes a winch 32, the winch ring 12, the cable 14 operably connected to the winch 32 to allow adjusting its effective length, and wound around a portion of the annular groove 20 of the winch ring 12, the housing 10 mounted to opposed sides of the winch ring 12, and a shackle 34 secured through the central aperture 16 of the winch ring 12. FIG. 1 shows the assembly 30 in use in a first (‘straight pull’) configuration where a free end 23 of the cable 14 is secured to a location 36 adjacent the winch 32 so that the cable 14 defines two parallel portions either side of the winch ring 12. FIG. 2 shows the assembly 30 in use in a second (‘directed/redirected pull’) configuration where the free end 23 of the cable 14 is secured to a location 38 spaced away from the winch 32 so that the cable 14 defines two non-parallel portions either side of the winch ring 12.

The winch 32 may be an electrically or mechanically powered mechanism installed to a vehicle (not illustrated) and be operable to cause moving the vehicle. In such applications, the winch 32 is typically fitted to, or behind, a bumper or bull bar of the vehicle. In the first configuration, the free end 23 of the cable 14 is typically secured to a towing point on or adjacent the bumper or bull bar, and the shackle 34 secured to a static structure, such as a tree, or another vehicle, to position the winch ring 12 in front of the vehicle. In the second configuration, the free end 23 of the cable 14 is secured to a static structure or another vehicle arranged in front and to one side of the vehicle, and the shackle is secured to a further structure to position the winch ring 12 in front of the vehicle. In either arrangement, the winch 32 is operable alone, or concurrently with driving the vehicle, to pull the vehicle forwards, towards the winch ring 12. In the second configuration, this can usefully redirect motion of the vehicle relative to the location of the free end 23 of the cable 14.

In either of the configurations illustrated in FIGS. 1 and 2, operating the winch 32 to retract the cable 14 typically causes the winch ring 12, or at least the peripheral region of the ring 12 defining the annular groove 20, to rotate about its axis 18 and relative to the shackle 34. The housing 10 is mountable to the winch ring 12 to permit rotation of the winch ring 12 relative to the housing 10. In the illustrated embodiment, the gripping members 24 are configured to abut opposed sides of the winch ring 12 to allow the sides of the ring 12 to slide against the members 24.

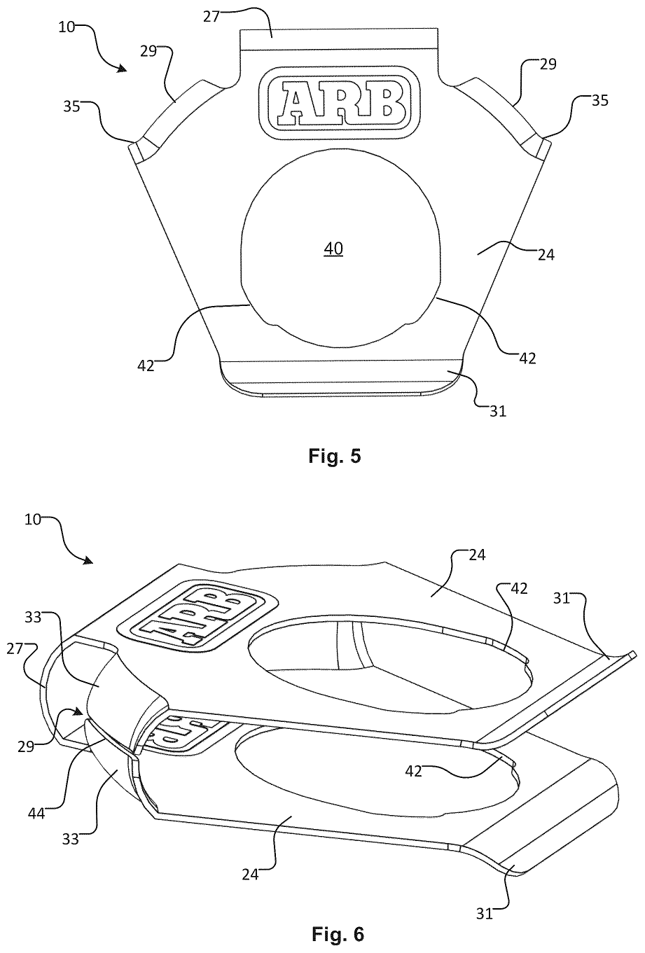

In this embodiment, the winch ring 12 includes a body 36 (FIG. 3) defining the annular groove 20 and the central aperture 16, and a hub 38 (FIG. 3) mounted to the body 36 in the central aperture 16, and the gripping members 24 are mountable to the hub 38. The hub 38 is fixedly secured to the body 36 such that the body 36 and hub 38 are rotatably locked, and the hub 38 rotates relative to, and slides against, the gripping members 24. In other embodiments, the hub 38 is rotatably connected to the body 36 to allow relative rotation, for example, by a bearing arranged to allow the body 26 to rotate about the hub 38. In such embodiments, the housing 10 may be mountable to the hub 38 to be rotatably locked with the hub 38. In this configuration, in use, the hub 38 and housing 10 may remain substantially static while the body 36 is rotated by the cable 14 being drawn about the ring 12 by the winch 32.

In other embodiments, the winch ring 12 and/or gripping members 24 may carry a bearing plate (not illustrated) arranged so that mounting the gripping members 24 to the sides of the ring 12 places the bearing plate against the ring 12 to reduce friction generated during relative rotation. In such embodiments, the bearing plate may be configured as a low friction and/or self-lubricating plate, such as a nylon disk, or may be associated with a bearing mechanism, such as races carrying ball bearings. Alternatively or additionally, each gripping member 24 may be configured to engage an annular groove or rib defined on a side of the winch ring (not illustrated) to mount the housing 10 on the ring 12 and permit relative rotation.

FIG. 1 illustrates the cable 14 being drawn towards the winch 32 causing rotation of the winch ring 12 and housing 10 anticlockwise about the axis 18. In this embodiment, the housing 10 includes a plurality of the bridging portions 26, comprising a central bridging portion 27 interposed between a pair of spaced side bridging portions 29. Rotation of the housing 10 as illustrated causes one of the side bridging portions 29 to collide with the cable 14, inhibiting further rotation of the housing 10 but permitting continued rotation of the winch ring 12.

FIG. 2 illustrates the cable 14 being drawn towards the winch 32 to cause the cable to tension and collide with both of the side bridging portions 29. In this embodiment, the bridging portions 27, 29 are arranged to extend around at least 90 degrees about the axis 18 of the winch ring 12. This configuration of the bridging portions 27, 29 means that when the cable 14 is tensioned, as illustrated, the side bridging portions 29 collide with the cable 14 to maintain the cable 14 being wrapped around at least one quarter of the periphery of the winch ring 12. Restricting the cable 14 in this way inhibits the tensioned cable 14 from straightening, which could cause removal of the housing 10 from the winch ring 12. It will be appreciated that while three bridging portions 27, 29 are shown in the illustrated housing 10, other embodiments may include more, or less bridging portions 26, including only a single bridging portion 26 extending around 90 degrees or more about the axis 18.

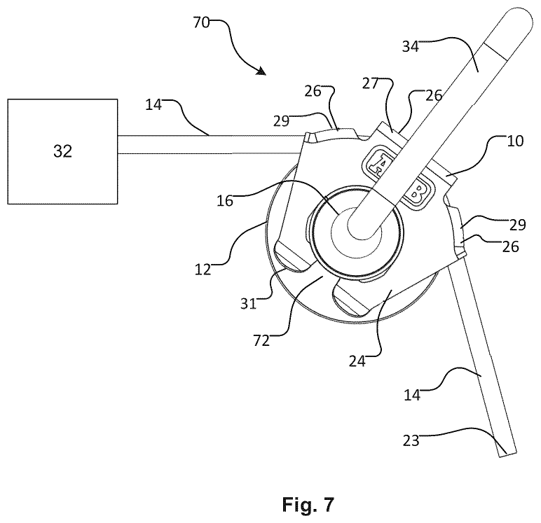

FIGS. 3 and 4 illustrate an alternative assembly 50 for carrying the winch cable 14. The assembly 50 comprises only the winch ring 12 and the housing 10. The housing 10 is shown dismounted and spaced from the winch ring 12. FIGS. 5 and 6 show the housing 10 in isolation.

The gripping member 24 are generally configured to be biased towards each other to enhance gripping the opposed sides of the winch ring 12. In the illustrated embodiment of the housing 10, the gripping members 24 and bridging portions 27, 29 are integrally formed such that the gripping members 24 are resiliently pivotable relative to the central bridging portion 29. In some embodiments, the gripping members 24 and bridging portions 27, 29 are formed from a single piece of formed sheet metal. In other embodiments, the housing 10 is formed from two halves and joined to each other partway across the central bridging portion 27, where the halves may be formed sheet metal and/or moulded plastic. In yet other embodiments (not illustrated), the central bridging portion 27 is joined to one, or each, of the gripping members 24 by a hinge. In such embodiments, the hinge may be associated with a biasing mechanism, such as a torsion spring, to bias the gripping members towards each other. In yet other embodiments, at least a portion of the central bridging portion 27 is formed from a resilient deformable material, such as an elastomer, to act as a hinge between the gripping members 24, and bias the members 24 towards each other.

Best shown in FIGS. 4 and 6, the gripping members 24 are spaced apart to receive the winch ring 12 between the members 24 to releasably mount the housing 10 on the winch ring 12. Each gripping member 24 defines a free end 25 extending away from the central bridging portion 27. A portion 31 of each gripping member 24 adjacent the free end 25 is arranged to diverge away from the corresponding portion 31 of the other gripping member 24 to form a lead-in arranged to receive the winch ring 12. Shaping the gripping members 24 in this way can enhance insertion of the winch ring 12 between the gripping members 24. The diverging portions 31 are in this embodiment define a curved section. Additionally or alternatively, these portions 31 may define one or more kinks.

At least one of the gripping members 24 may be shaped to encircle the central aperture 16 of the winch ring 12. This arrangement can enhance securely mounting the housing 10 to the winch ring 12, particularly where the shackle 34, or other structure, is secured through the central aperture 16. In the illustrated embodiment, both gripping members 24 define an aperture 40 dimensioned to surround the hub 38 arranged through the central aperture 16. Arranging the aperture 40 about the hub 38 allows securely mounting the housing 10 to the winch ring 12 while allowing relative rotation of the winch ring 12 and housing 10. In other embodiments (not illustrated), the gripping members 24 are shaped to only partially surround the central aperture 16, for example, where the gripping member 24 are configured to engage a groove or rib defined by the sides of the ring 12, as described above.

Best shown in FIGS. 5 and 6, each gripping member 24 may define at least one cut out 42 arranged to centralise the aperture 40 on the hub 38. In this embodiment, each gripping member 24 defines a pair of the cut outs 42 around a periphery of the aperture 40. The cut outs 42 are shaped and positioned to align the aperture 40 with the hub 38 when mounting the housing 10 to the winch ring 12. It will be appreciated that each gripping member 24 may define more, or less, cut outs 42, and that the cut outs 42 may be alternatively shaped to achieve the same purpose.

Also shown in FIGS. 4 and 6, each side bridging portion 29 defines a split 44 dividing the bridging portion 29 into two sections 33. This arrangement allows the sections 33 of each side bridging portion 29 to be spaced apart as the winch ring 12 is inserted between the gripping members 24, causing the central bridging portion 27 to act as a hinge. The spacing between the gripping members 24 is dimensioned such that when the hub 38 is positioned within the aperture 40 the gripping members snap fit to the winch ring 12. In other embodiments (not illustrated), the bridging portions 29 may carry, or be partially formed by, resiliently deformable material in place of the splits 44 to allow deformation of the bridging portions 29 during mounting to the winch ring 12.

Best shown in FIG. 5, each side bridging portion 29 defines a flared outer edge section 35. These sections 35 are shaped to inhibit the housing 10 snagging on the cable 14, which can enhance the cable 14 gliding past the housing 10 as the cable 14 is drawn around the winch ring 12.

FIG. 7 shows an alternative assembly 70 sharing many of the features of the assembly 30 shown in FIGS. 1 and 2, whereby common reference numerals indicate common features, unless indicated otherwise. In this embodiment, the housing 10 is configured so that each gripping member 24 is shaped to only partially surround the central aperture 16 to define a gap 72. The gap 72 is dimensioned to allow the shackle 34 to pass therethrough. This arrangement can usefully allow the housing 10 to be fitted to the winch ring 12 when the shackle 34 is secured through the aperture 16.

Assembling the housing 10 to the winch ring 12 involves winding the cable 14 about a portion of the annular groove 20, and positioning the winch ring 12 between the gripping members 24 to mount the gripping members 24 to the sides of the winch ring 12. When mounted, the bridging portions 26 extend across the annular groove 20 to inhibit removal of the cable 14 from the winch ring 12.

When used as part of the assembly 30, the shackle 34 is secured through the central aperture 16 of the winch ring 12 after the housing 10 is mounted to the ring 12. In embodiments of the housing 10 configured to surround the aperture 16 when mounted to the winch ring 12, such as illustrated in FIGS. 1 and 2, the shackle 34 is also secured through the housing 10.

Use of the housing 10 as part of the assembly 30 involves the cable 14 being drawn in one direction around the axis 18 of the winch ring 12 and towards the winch 32 to tension the cable 14, or the cable 14 being released by the winch 32 to cause the cable to slacken and move in the other direction about the axis 18. These actions cause rotation of the winch ring 12 relative to the housing 10. Before tensioning the cable 14, the winch ring 12, portion of the cable 14 wrapped around the ring 12, and the housing 10 may be a tangled heap. Tensioning the cable 14 may draw the cable 14 out of the heap to elevate the winch ring 12 and associated housing 10 to be supported by the tensioned cable 14.

The housing 10 may advantageously inhibit, or prevent, the cable 14 being inadvertently removed, dislodged, or otherwise separated from the winch ring 12 during winching operations, and particularly may retain the cable 14 within the annular groove 20 of the ring 12. This can enhance efficiency of winching by reducing, or avoiding altogether, instances of the cable 14 slipping off the ring 12.

The housing 10 is readily mountable, and removable from, the winch ring 12, and may be securely positioned on the ring 12 such as to avoid inadvertent removal. The housing 10 may therefore provide a low complexity solution to reliably inhibiting removal of the cable 14 from the ring 12.

The housing 10 is shaped so that the gripping members 24 at least partially cover the sides of the winch ring 12. When used as part of the assembly 30, 70 including the shackle 34, the configuration of the gripping members 24 typically prevents the shackle 34 contacting the winch ring 12 to inhibit fretting of the rotating ring 12 against the fibers of the shackle 34, which can otherwise cause wear.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A housing for a winch ring carrying a cable, the winch ring defining a central aperture having an axis, and a peripheral region defining an annular groove for receiving the cable, the housing including:
opposed gripping members joined by at least one bridging portion, each gripping member configured to be releasably mountable to a side of the winch ring to position the at least one bridging portion across the annular groove, the at least one bridging portion shaped to extend about the axis to enclose a portion of the annular groove to inhibit removal of the cable from the winch ring,
the gripping members being mountable to the winch ring to permit relative rotation of the peripheral region and the housing about the axis, and at least one of the gripping members shaped to at least partially surround the central aperture to allow access through the central aperture.

2. The housing of claim 1, wherein the gripping members are biased towards each other.

3. The housing of claim 1, wherein the gripping members and the at least one bridging portion are integrally formed such that the gripping members are resiliently pivotable relative to the at least one bridging portion.

4. The housing of claim 2, wherein each gripping member defines a free end extending away from the at least one bridging portion, and a portion of each gripping member adjacent the free end is arranged to diverge away from the corresponding portion of the other gripping member.

5. The housing of claim 1, wherein the at least one of the gripping members is shaped to encircle the central aperture.

6. The housing of claim 1, wherein each gripping member defines an aperture dimensioned to surround a hub arranged through the central aperture, and each gripping member defines at least one cut out arranged to centralise the aperture on the hub.

7. The housing of claim 1, wherein the at least one bridging portion is arranged to extend around at least 90 degrees about the axis of the winch ring.

8. The housing of claim 7 including a central bridging portion interposed between a pair of spaced side bridging portions, and wherein the bridging portions are arranged to extend about more than 90 degrees about the axis of the winch ring.

9. The housing of claim 8, wherein each side bridging portion defines a split extending perpendicular to the axis to divide the side bridging portion into two sections, whereby the two sections are separable when the gripping members are urged apart when being mounted on the winch ring.

10. The housing of claim 8, wherein each side bridging portion defines a flared outer edge section.

11. An assembly for carrying a winch cable, the assembly including:
a winch ring defining a central aperture, and a peripheral annular groove for receiving the winch cable; and
a housing having opposed gripping members joined by at least one bridging portion, each gripping member configured to be releasably mountable to a side of the winch ring to position the at least one bridging portion across the annular groove, the at least one bridging portion shaped to extend about the axis to enclose a portion of the annular groove to inhibit removal of the cable from the winch ring, the gripping members being mountable to the winch ring to permit relative rotation about the axis, and at least one of the gripping members shaped to at least partially surround the central aperture to allow access through the central aperture.

12. The assembly of claim 11, wherein the winch ring includes a body defining the annular groove and the central aperture, and a hub mounted to the body in the central aperture, and wherein the gripping members are mountable to the hub.

13. The assembly of claim 12, wherein the hub is fixedly secured to the body such that the hub is rotatably locked to the body.

14. The assembly of claim 13, wherein the hub defines a rounded entrance and exit to the central aperture.

15. A winch assembly including:
an electrically powered winch connected to a cable and operable to wind the cable to adjust its effective length;
a winch ring defining a central aperture, and a peripheral annular groove for receiving the cable; and
a housing having opposed gripping members joined by at least one bridging portion, each gripping member configured to be releasably mountable to a side of the winch ring to position the at least one bridging portion across the annular groove, the at least one bridging portion shaped to extend about the axis to enclose a portion of the annular groove to inhibit removal of the cable from the winch ring, the gripping members being mountable to the winch ring to permit relative rotation about the axis, and at least one of the gripping members shaped to at least partially surround the central aperture to allow access through the central aperture.

16. The winch assembly of claim 15 including a shackle releasably securable through the central aperture.
